(19) United States
(12) Patent Application Publication
(10) Pub. No.: US 2013/0224333 A1
(43) Pub. Date: Aug. 29, 2013

(54) FERMENTATION PROCESS TO PRODUCE NATURAL CAROTENOIDS AND CAROTENOID-ENRICHED FEED PRODUCTS

(71) Applicants: Ananda Nanjundaswamy, Montgomery, AL (US); Praveen V. Vadlani, Manhattan, KS (US)

(72) Inventors: Ananda Nanjundaswamy, Montgomery, AL (US); Praveen V. Vadlani, Manhattan, KS (US)

(73) Assignee: Kansas State University Research Foundation, Manhattan, KS (US)

(21) Appl. No.: 13/882,008

(22) PCT Filed: Oct. 26, 2011
(86) PCT No.: PCT/US11/57835

§ 371 Date: Apr. 26, 2013

Related U.S. Application Data
(60) Provisional application No. 61/406,904, filed on Oct. 26, 2010.

(51) Int. Cl. A23K 1/00

(52) U.S. Cl. CPC A23K 1/007
USPC 426/2; 426/7; 426/60; 426/31; 426/46; 426/62

(57) ABSTRACT

Methods of fortifying animal feeds nutrients typically lacking therefrom through the action of microorganisms are provided. Fermentation of animal feed materials with selected microorganisms, such as certain varieties of red yeasts, are shown to fortify the feed materials with natural carotenoids. Further, in certain embodiments, these methods can result in an increase in levels of nutritionally beneficial fatty acids, and a decrease in dietary fiber and nitrogen levels.

### RELATED APPLICATION

This application claims the benefit of U.S. Provisional Patent Application No. 61/406,904, entitled, “Red Yeast Fermentation to Produce Natural Astaxanthin and B-Carotene Enriched Fish-Meal,” filed Oct. 26, 2010, incorporated by reference herein in its entirety.

### BACKGROUND OF THE INVENTION

1. Field of the Invention

The present invention is generally directed toward in situ fortification of animal feed products with nutrients that are typically lacking therefrom. In one aspect, methods for fortifying animal feeds involve fermentation of an animal feed medium comprising one or more microorganisms that are capable of producing the desired nutrients, such as carotenoids. The fortified feed materials are recovered from the fermentation medium and used in animal feed products. Thus, the need for fortifying or supplementing the animal feed products with certain previously-isolated nutrients is avoided.

2. Description of the Prior Art

Animal feeds are often poor in certain desirable nutrients that promote the animal's health. Therefore, nutrient supplements are added to animal feeds, such as distillers dried grain with solubles (DDGS), in order to improve their nutritional value. Carotenoids are exemplary, highly-beneficial nutrients that animal feeds often naturally lack. Carotenoids are tetraterpenoid organic pigments that are naturally occurring in the chloroplasts and chromoplasts of certain plants and certain bacteria. Carotenoids can function as anticarcinogens, immunomodulators, natural colorants, and cell membrane stabilizers. Even though most animals are incapable of producing carotenoids, animals are generally able to assimilate ingested carotenoids and employ them in various ways in metabolism. Thus, animals must obtain these desired carotenoids through their diet.

Astaxanthin and β-carotene are important carotenoids in food and feed industry. Astaxanthin is a xanthophyl found in microalgae, yeast, and certain aquatic life such as salmon, trout, krill, shrip, crayfish, and crustaceans. Astaxanthin is vital in aquaculture feed. It improves egg quality and fry survival, protects against oxidation of lipids in salmon which contain high levels of polyunsaturated fatty acids, has pro-vitamin A activity, improves fish liver histology and improves shrimp and prawn survival. β-carotene, along with lycopene, is a hydrocarbon carotenoid and a vitamin A precursor.

Carotenoids, such as astaxanthin and beta-carotene, can be extracted from natural sources or produced synthetically. However, due to societal trends which disfavor synthetic food additives, natural carotenoids are preferred over synthetic carotenoids. Further, it has been discovered that natural carotenoids can provide greater health benefits than synthetic carotenoids. For example, natural carotenoids comprise a mixture of different stereoisomers. Synthetic carotenoids tend to comprise a single isomer. Thus, low dosages of naturally occurring carotenoids can be as potent as larger doses of synthetic carotenoids.

Despite the perceived advantages of natural carotenoids over synthetic carotenoids, synthetic carotenoids tend to be preferred in animal diets because they are generally less expensive to produce. Exemplary recommended dosages of carotenoids include: 30-120 mg/kg of total carotenoids in aquaculture feed, 1-50 mg/day to enhance immune response, and 40 mg astaxanthin/kg feed in egg laying hens to enhance color of egg yolk and flesh of poultry.

Natural astaxanthin can be obtained from algae, such as Hematococcus pluvialis, red yeast, such as Phaffia rhodozyma, or from shrimp waste. Aquasta® is a commercially available astaxanthin from P. rhodozyma produced by Naturxan (ADM Company). Aquasta® is produced by fermentation of dextrose and the astaxanthin is extracted from yeast cells by enzymatic cell disruption and spray drying. The powdered astaxanthin is added to aquaculture feed as a supplement. However, extracting and isolating the astaxanthin requires much effort and leads to increased feed production costs.

β-carotene is produced by Sporobolomyces roseus, which is commonly found on phylloplanes of different types of plants. S. roseus produces other carotenoids such as torulene and torularhodin. Again, much like astaxanthin, β-carotene must be extracted and isolated before being added as a supplement to animal feeds.

### SUMMARY OF THE INVENTION

The present invention overcomes the problems described above by providing methods for producing animal feed products from feed materials that contain high levels of naturally occurring nutrients, especially carotenoids.

According to one embodiment of the present invention, there is provided a method of making an animal feed product. The method generally comprises introducing into a feed material at least one microorganism species capable of synthesizing one or more nutrients. The microorganism and feed material are then subjected to conditions favorable for formation of the one or more nutrients by the microorganism thereby creating a nutrient-enriched feed material. The nutrient-enriched feed material may then undergo additional processing resulting in the finished animal feed product.

In particular embodiments, various species of yeast that are capable of synthesizing one or more desired nutrients, especially carotenoids, are added to an organic feed material. The feed material and yeast are then fermented, which results in the yeast synthesizing the desired nutrients. The fermentation mixture can then be dried or otherwise processed into an animal feed product that includes the nutrients synthesized during the fermentation process.

In other embodiments according to the present invention, there is provided an animal feed product that is made in accordance with the methods described herein. Alternatively, the animal feed product comprises a solid byproduct of a fermentation process, residues of a carotenoid-producing yeast, and one or more carotenoids. In particular embodiments, the carotenoids are present in the animal feed product at a level of at least about 100 mg per kg of animal feed product.

In still another embodiment according to the present invention, there is provided a method of feeding an animal by feeding to the animal an animal feed product as described herein.

### BRIEF DESCRIPTION OF THE DRAWINGS

FIG. 1 is a graph illustrating astaxanthin production from the fermentation of fish meal; and

FIG. 2 is a graph illustrating β-carotene production from the fermentation of fish meal; and

FIG. 3 is a schematic diagram illustrating a path to providing carotenoid-enriched animal feed products.

### DETAILED DESCRIPTION OF THE PREFERRED EMBODIMENT

The present invention provides an economical way of fortifying animal feeds with nutrients, particularly biological or natural nutrients, without having to perform a separate nutrient synthesis and extraction process. In this manner, the material comprising the animal feed is directly enriched through the action of nutrient-producing microorganisms. The enriched material can then be directly formed or incorporated into a finished animal feed product.

A starting point for preparing the nutrient-enriched feed materials is the identification of a feed material and microorganism species capable of synthesizing the desired nutrient(s). The feed material can be any material from which an animal feed product can be made. In certain embodiments, particularly feed products for aquaculture, an exemplary starting material or substrate is fish meal. In other embodiments, the starting material may be plant-based or cellulosic in nature. Exemplary plant-based materials include cereal grain materials and legume materials. More specifically, the feed material that will be enriched may comprise one or more members selected from the group consisting of fish meal, DDGS, soy flour, soy meal, soy hull, wheat bran, rice bran, corn meal, milo whole stillage, and corn whole stillage.

Selection of the microorganism species is based largely upon the desired nutrient to be introduced into the feed material. However, as illustrated in the examples, the desired feed material may also impact the selection of an appropriate microorganism or microorganisms. It has been discovered that the feed material itself may affect nutrient production levels for a particular microorganism. Essentially, any microorganism species that is capable of producing a desired nutrient may be used with the present invention. Exemplary desirable nutrients for fortification of animal feed include carotenoids, enzymes, proteins, amino acids, fatty acids, lipids, vitamins, and minerals. In particular embodiments, carotenoids, especially astaxanthin, β-carotene, canthaxanthin, tourlene, torularhodin, and luetein are desirable fortifying nutrients as most animals are generally incapable of synthesizing these materials. Importantly, the carotenoids produced are natural mixtures of stereoisomers of the individual carotenoids, as opposed to a single isomer that is most commonly produced with artificially synthesized carotenoids.

In certain embodiments, the at least one microorganism to be introduced into the feed material may comprise a species of bacteria or fungi. In particular embodiments, the microorganism may be a yeast, such as a member of the phylum Basidiomycota, and particularly imperfect species thereof. Exemplary yeasts that may be used in the present invention include Phaffia rhodozyma, Sporobolomyces roseus, or a combination thereof. Combinations of more than one different microorganism species may be employed in order to provide optimal fortification of the feed material. Further consideration is given to selection of microorganisms that are approved for incorporation into an animal feed product and thus do not require removal from the fortified feed material prior to manufacture of the finished feed product.

The mixture of the feed material and at least one microorganism species is subjected to conditions favorable for forming the desired nutrient(s) by the microorganism, resulting in the creation of a nutrient-enriched feed material. In certain embodiments, this entails subjecting the feed material and microorganism to a fermentation process. The feed material and at least one microorganism species are incorporated into a fermentation medium and maintained at appropriate fermentation conditions for a desired length of time. In certain embodiments, the fermentation may be a batch-type, continuous, semi-solid, solid-state, or submerged fermentation process. The precise fermentation conditions, including the temperature, pH, aeration, stirring speed, and light exposure, may be monitored and closely controlled so as to optimize nutrient production levels.

The fermentation medium may also contain additives that are directed toward improving production of the desired nutrients during fermentation. In certain embodiments, these additives provide an additional source of carbon, nitrogen, or trace elements. In particular embodiments, the additives are selected from the group consisting of glycerol (carbon source), corn steep liquor (organic nitrogen source), vitamins, minerals, terpene precursors, and mixtures thereof. In certain embodiments, carotenoid product can be improved through the addition of certain terpene precursors such as mevalonic acid and those found in apple and tomato pomace. (Tomato and apple pomace contain carotenoids such as lycopene and β-carotene that can be used to synthesize alternate carotenoids such as astaxanthin.) Exemplary minerals that may be added to the fermentation medium include KH₂PO₄, MgSO₄, and ZnSO₄.

The amounts of the additives incorporated into the fermentation medium can vary depending upon the particular additive. In certain embodiments that incorporate glycerol as an additional carbon source, the glycerol may be added to the fermentation medium at a level of between about 1% to about 10% by weight, or more specifically, between about 2.5% to about 8% by weight based on the weight of the fermentation medium. The various minerals and certain terpene precursors, such as mevalonic acid, may be added to the fermentation medium at a level of between about 0.1 to about 5 g/l each, or more specifically between about 0.5 to about 2 g/l each. Apple and tomato pomace may be added to the fermentation medium at a level of about 0.01% to about 2% by weight, or between about 0.05% to about 1.5% by weight, or between about 0.075% to about 1% by weight.

In certain embodiments, the fermentation process also results in a decrease in fiber content of the feed material. Certain animals digest dietary fiber poorly. Thus, feed materials that are high in fiber can be used in only limited amounts in manufacture of animal feed products. It was discovered that during the enrichment process, the dietary fiber levels of the feed materials is decreased. In certain embodiments, the levels of dietary fiber in the feed material is reduced by at least 25%, or at least 50%, or even at least 75% during the enrichment process. This feature permits the enriched feed materials to be incorporated into finished feed products at much greater levels. Further, the fermentation process was shown to reduce nitrogen levels and elevate levels of certain fatty acids, such as vaccenic acid. Certain feed materials are naturally low in some fatty acids, and thus must be fortified with fats and oils before being fed to animals. The increased fatty acid levels attributable to the fermentation process can reduce or eliminate the requirement for this fortification. In addition, the reduced nitrogen levels may be useful in reducing nitrogen content of animal wastes and fish farm effluents. Further, in certain embodiments, the fermentation process results in a decrease in trypsin inhibitor level of the enriched feed product as compared to the starting feed material, especially for soybean products.

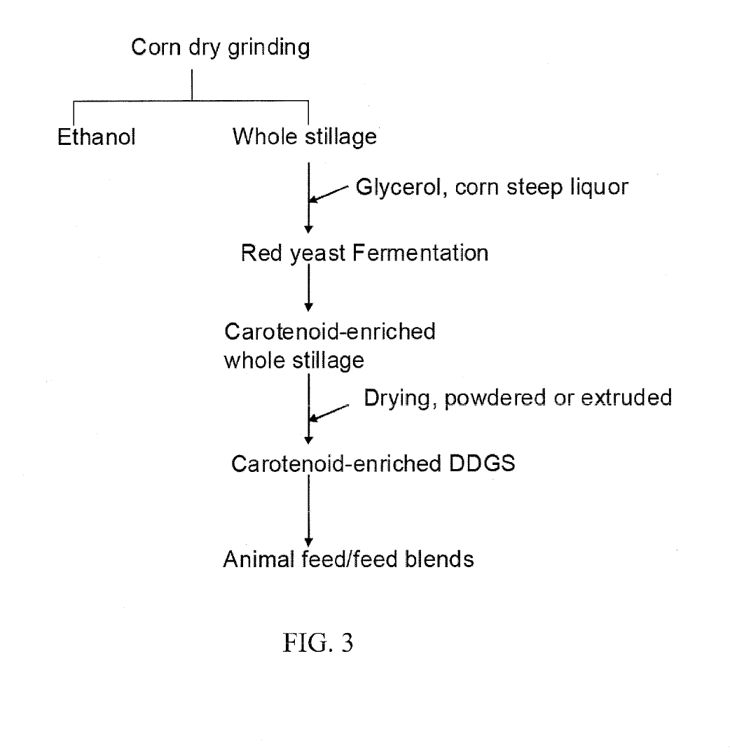

In certain embodiments, it will be appreciated that the feed material is a co-product of a prior fermentation process. For example, the feed material may be a co-product from a corn or milo ethanol fermentation process, such as whole stillage, thin stillage, or products derived therefrom including distillers wet grains (DWG), dried distillers grains (DDG), DDGS, and distillers solubles (DS). It is these products from the primary fermentation that may be used as the feed material for a secondary fermentation process utilizing carotenoid-producing yeasts. Thus, the secondary fermentation provides nutrient enrichment not offered by the primary fermentation process. FIG. 3 illustrates an exemplary pathway for providing carotenoid-enriched DDGS through a secondary fermentation process.

The nutrient-enriched feed material may be processed into an animal feed product. In certain embodiments, this processing includes drying of the nutrient-enriched feed material that resulted from the fermentation process. Exemplary drying operations include freeze drying, oven drying, and sun drying. The dried, enriched material may then be further processed and formed into a finished animal feed product. Such further processing can include blending the enriched material with other feed additives such as DDGS, soybean products, wheat bran, rice bran and corn meal. The material may also be extruded, undergo enzymatic hydrolysis, and high-pressure and high-temperature treatments in order to release the nutrients from the microorganism cells for better nutrient bioavailability. The feed material may also be pelletized or otherwise formed into appropriately sized and shaped products for feeding to an animal. It is noteworthy that in general the processing of the enriched feed material into a finished feed product does not involve the removal or separation of the microorganisms added to the feed material. By permitting the microorganisms to be passed through into the final feed product, significant production cost savings are realized.

Methods according to the present invention result in the creation of nutrient-fortified animal feed products in a highly economical manner compared to feed products in which previously-isolated nutrients are introduced. In certain embodiments, animal feed products obtained generally comprise a solid byproduct of a fermentation process, a carotenoid-producing yeast or residue thereof, and one or more carotenoid compounds that would not otherwise be present in the solid material had it not been subjected to a fermentation process as described herein.

The fermentation byproduct predominantly comprises the feed material or residue thereof that was added to the fermentation medium. In particular embodiments, the fermentation byproduct comprises a cellulosic material, or residue thereof, such as DDGS, soy flour, soy meal, soy hull, wheat bran, rice bran, corn meal, milo whole stillage, and corn whole stillage. In other embodiments, the fermentation byproduct comprises fish meal or residue thereof.

The carotenoid-producing yeast present in the feed product was originally added as a part of the fermentation process. As noted previously, exemplary carotenoid-producing yeasts include Phaffia rhodozyma, Sporobolomyces roseus, and combinations thereof. If the yeast organism is destroyed during formation of the feed product, residues of the yeast will remain and be passed through into the finished feed product.

The one or more carotenoids present in the animal feed product are produced by the yeast during the fermentation process. In certain embodiments, the one or more carotenoids are not generally present in the raw feed material that undergoes fermentation, but rather are produced by the yeast as a result of the fermentation. In particular embodiments, the one or more carotenoids are selected from the group consisting of astaxanthin, β-carotene, canthaxanthin, tourlene, torularhodin, luetein, and mixtures thereof. Again, the carotenoids generally comprise a natural mixture of stereoisomers as opposed to a single isomer that would be indicative of a chemically synthesized carotenoid.

In certain embodiments, the total carotenoid content of the animal feed product is at least 100 mg per kg of the animal feed product. In other embodiments, the one or more carotenoids are present in the animal feed product at a level of between about 100 mg to about 1200 mg per kg of the animal feed product, and more particularly, between about 200 to about 900 mg per kg of the animal feed product.

The animal feed product may also contain additional components that are synthesized during the fermentation process. These additional components may include glucans, mannans, and glucosamine.

The carotenoids contained in the carotenoid-enriched feed materials tend to exhibit long-term stability thereby permitting the enriched feed materials to be incorporated into shelf-stable feed products. In one embodiment, after six months of storage at room temperature (approximately 25° C.), at least 80% of the initial carotenoid content remains. In other embodiments, after six months of storage at room temperature, at least 85% or even at least 90% of the initial carotenoid content remains.

Animal feed products made in accordance with the present invention can be tailor made to suit the nutritional requirements of many different kinds of animals. For example, feeds made from fish meal are particularly suited for feeding to aquaculture such as salmon and trout. Feeds made from cereal grains and other cellulosic sources may be fortified and fed to ruminant livestock animals, such as cattle, goats and sheep, and non-ruminant animals, such as poultry and hogs. Thus, the present invention provides methods for feeding these animals a nutrient-fortified feed product.

### EXAMPLES

The following examples set forth exemplary methods according to the present invention for in situ generation of carotenoids in materials from which animal feed products are prepared. It is to be understood, however, that these examples are provided by way of illustration and nothing therein should be taken as a limitation upon the overall scope of the invention.

### Example 1

In this example, the preparation of a carotenoid-rich fish meal product was examined using fermentation processes. Lyophilized cultures of red yeasts P. rhodozyma (ATCC 24202) and S. roseus (ATCC 28988) were obtained from American Type Culture Collection (ATCC, Manassas, Va.). Astaxanthin and β-carotene were the only carotenoids examined in this study. The selected strain of P. rhodozyma produces astaxanthin and β-carotene, whereas the S. roseus strain produces only β-carotene.

Inoculum was prepared by inoculating a loopful of cells from respective slants into sterile 100 ml yeast extract malt extract broth (YMB) in 500 ml flasks and incubated at 18° C. and 180 rpm for 72 h. Development of orange and red color in P. rhodozyma and S. roseus flasks, respectively, indicated good fungal growth. A 10% (v/v) inoculum was used. For monoculture fermentation, 10 ml of each strain was used for media inoculation, and 5 ml of each strain was used for mixed culture fermentation.

A liter of the basal fermentation medium contained 5% fish meal, 5% glycerol and the following minerals: 1 g KH₂PO₄, 0.5 g MgSO₄, 0.5 g MnSO₄, and 0.5 g ZnSO₄. Media pH ranged from 5.5 to 6.0 before sterilization and was not adjusted further. Media were sterilized by autoclaving at 121° C. for 30 min.

About 100 ml of medium was taken in 500 ml flasks per fungal treatment. Two replicates per treatment were maintained. The flasks were inoculated and incubated at 18° C. and 180 rpm for 11 days. Samples were harvested on days 3, 5, 7, 9, and 11 and were freeze-dried for 24 h and stored at −80° C. until further analysis.

Carotenoids were isolated by grinding the freeze-dried samples with 0.2 g of acid-washed sand, and the extracting the carotenoids in dichloromethane solvent. Samples were centrifuged, and the supernatant was filtered into 1.5-ml HPLC vials through 0.2-μm filters. A Shimadzu HPLC equipped with LC-20AB pump, SIL-20AC autosampler, SPD-M20A PDA detector, and CTO-20A column oven was used to quantify carotenoids. A Phenomenex Prodigy C18 column (150 mm length and 4.6 mm internal diameter) along with a C18 guard column was used to separate carotenoids. Astaxanthin and β-carotene standards were obtained from Sigma Aldrich (St Louis, Mo., USA). Carotenoid yield was expressed as μg per gram of freeze-dried sample instead of per gram of yeast cells as it was not impossible to sediment only yeast cells from the fermented sample.

Nutrition composition analyses of the samples were conducted to evaluate crude fat and protein. About 5 g of representative sample from each treatment was sent to an analytical lab in the Animal Science and Industry Department at Kansas State University for analyses of crude protein and fat.

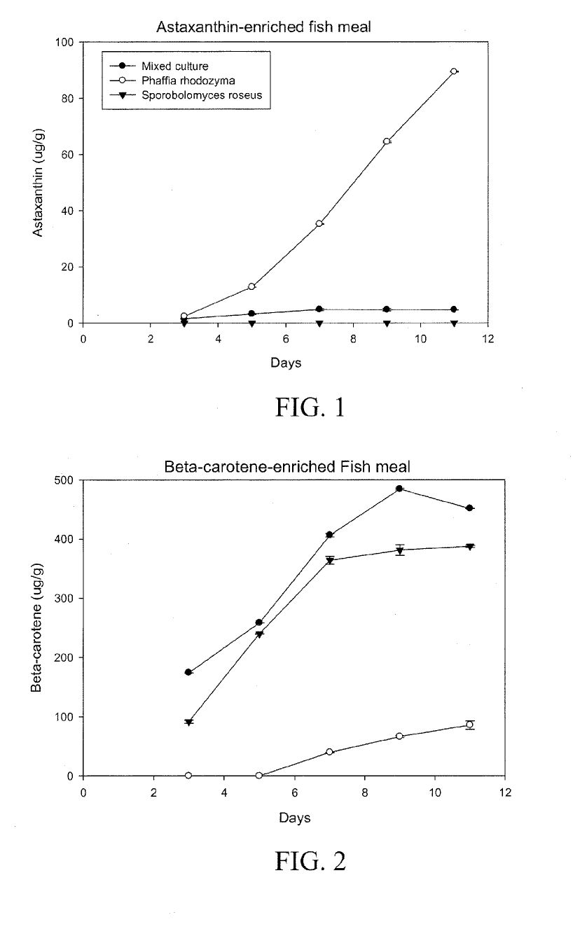

Overall, P. rhodozyma and mixed culture fermentation produced the best astaxanthin and β-carotene yield of 89 mg/kg on day 11 and 484 mg/kg on day 9, respectively. The production profile of astaxanthin and β-carotene are provided in FIGS. 1 and 2, respectively. In mixed culture fermentation, the best astaxanthin, β-carotene and total carotenoid yield was 5 mg/kg on day 7, 484 mg/kg on day 9, and 489 mg/kg on day 9, respectively. In P. rhodozyma, the best astaxanthin, β-carotene and total carotenoids yields of 89, 85 and 175 mg/kg, respectively, were obtained on day 11. In S. roseus, the best β-carotene yield of 388 mg/kg was obtained on day 11.

The percent crude fat and crude protein in the unfermented control fish meal sample were 9.6 and 58.5, respectively. About 28% reduction in % crude protein was observed in both mixed culture and monoculture fermentation. However, the % crude fat reduction in all the treatments varied, ranging from 76% in monoculture of P. rhodozyma to 100% in mixed culture and S. roseus. After fermentation, the carotenoid-enriched fish meal from P. rhodozyma contained 42.31% crude protein and 2.31% crude fat; the product from S. roseus contained 42.32% crude protein and 0.2% crude fat; and the product from the mixed culture contained 42.42% crude protein and 0% crude fat.

In this trial, it was confirmed that red yeast fermentation of fish meal yielded carotenoid-enriched fish meal. The total carotenoid content in the fish meal was more than the prescribed dosage, and the astaxanthin yield in P. rhodozyma fermentation was marginally higher than the recommended dosage. This was coupled with reduction in protein and fat content. To make tailor-made feed, carotenoid-enriched fish meal can be blended with regular fish meal to obtain the optimal concentration of nutrients including carotenoids, protein and fat.

### Example 2

In this example, the preparation of carotenoid-rich animal feeds from plant-based materials was examined using fermentation processes. Lyophilized cultures of red yeasts P. rhodozyma (ATCC 24202) and S. roseus (ATCC 28988) were obtained from American Type Culture Collection (ATCC, Manassas, Va.).

Inoculum for each fungal strain was prepared by inoculating a loopful of cells from respective slants into sterile 100-mL yeast extract-malt extract broth in 500-mL flasks and incubating them at 18° C. and 180 rpm for 72 hr. Development of orange and red color in P. rhodozyma and S. roseus flasks, respectively, indicated good fungal growth. A 10% (v/v) inoculum was used. For monoculture fermentation, 10 mL of each strain was used for media inoculation, and 5 mL of each strain was used for mixed-culture fermentation.

Eight substrates were used in this study: defatted and full-fat rice bran (Nutracea, Phoenix, Ariz.), milo (grain sorghum) whole stillage (Nesika Energy, Scandia, Kans.), full-fat soy flour (Barry Farm, Wapakoneta, Ohio), defatted soy flour, soy meal, soy hull, and wheat bran (Kansas State University Department of Grain Science and Industry, Manhattan, Kans.). Defatted rice bran, full-fat rice bran, wheat bran, soy meal, and soy hull samples were ground with a UDY Cyclone lab sample mill (UDY, Ft. Collins, Colo.) at setting 0. Ground samples were sieved with U.S. standard sieve number 30 (sieve opening=0.0232 in., 590 μm), and the <600-μm fraction was used.

A liter of the basal fermentation medium contained 5% glycerol (w/v; ACS grade, Fischer Scientific, St. Louis, Mo.) and the following minerals: 1 g of KH₂PO₄, 0.5 g of MgSO₄, 0.5 g of MnSO₄, and 0.5 g ZnSO₄. Glycerol supplementation of the media was carried out because: glycerol can act as a carbon source for carotenoid production; carotenoid production is increased by the balanced and increased formation of acetyl-CoA, pyruvate, and glyceraldehyde-3-phosphate, all of which can be produced by glycolysis of glycerol; and glycerol is a cheap and abundantly produced co-product of the biodiesel and soap industries.

After initial evaluation using 5, 10, and 15% rice bran (data not shown), the 5% (dry weight basis) concentration was found to be ideal. Accordingly, all substrates except milo whole stillage were added to the basal media at 5% concentration because higher concentrations made the media highly viscous. Milo whole stillage was used at 25% (wet weight basis). Media pH ranged from 5.5 to 6.0 before sterilization and was not adjusted further. Media were sterilized by autoclaving at 121° C. for 30 min.

About 100 mL of respective media were taken in 500-mL flasks per fungal treatment. Each treatment received two replicates. The flasks were inoculated and then incubated at 18° C. and 180 rpm for 11 days. Samples were harvested on days 3, 5, 7, 9, and 11 and centrifuged. Quantification of glycerol utilization was used as a proxy for yeast growth. The supernatant was used for glycerol analysis, and the sediments were freeze-dried for 24 hr and stored at −80° C. until further analysis for carotenoids.

Freeze-dried samples were ground with 0.2 g of acid-washed sand, and carotenoids were extracted in dichloromethane solvent. Samples were centrifuged, and the supernatant was filtered into 1.5-mL HPLC vials through 0.2-μm filters. A Shimadzu HPLC equipped with an LC-20AB pump, SIL-20AC autosampler, SPD-M20A PDA detector, and CTO-20A column oven (Shimadzu, Kyoto, Japan) was used to quantify carotenoids. A Phenomenex Prodigy C18 column (150-mm length and 4.6-mm internal diameter) fitted with a C18 guard column (Phenomenex, Torrance, Calif.) was used to separate carotenoids. Astaxanthin and β-carotene standards were obtained from Sigma Aldrich (Saint Louis, Mo.). Carotenoid yield was expressed as μg per gram of freeze-dried sample instead of per gram of yeast cells, because it was not possible to sediment only yeast cells from the fermented sample.

About 100 mL of the supernatant was diluted 1:1 with water and filtered using 0.45 μm syringe filters, and samples were analyzed with a Shimadzu HPLC equipped with a refractory index detector and CTO-20A column oven at 80° C. Detector temperature was set at 60° C. Water was used as the mobile phase, with a flow rate of 0.6 mL/min. A Rezex organic acid column (300-mm length and 4.6-mm internal diameter) was used to quantify glycerol.

Pearson correlation between residual glycerol and carotenoid production for each treatment was carried out using PROC CORR at P=0.05 (SAS version 9.1.4, SAS Institute, Cary, N.C.).

Among all the substrates evaluated, the best astaxanthin and β-carotene yields were produced by P. rhodozyma monoculture on full-fat rice bran (80 μg/g) and S. roseus on full-fat soy flour (836 μg/g), respectively (see, Table 1). Among the three yeast treatments per substrate, P. rhodozyma produced the highest astaxanthin yield. The highest β-carotene yields were produced by the mixed culture in milo whole stillage and rice bran, by P. rhodozyma monoculture in soy hull, and by S. roseus monoculture in full-fat soy flour, defatted soy flour, soy meal, defatted rice bran, and wheat bran. Soy hull was a poor substrate for carotenoid value addition: the mixed culture produced no astaxanthin and the S. roseus monoculture no β-carotene.

TABLE 1
Carotenoid Yield on Different Substrates by Red Yeast Fermentation

| Substrate | Fungus^{b} | Compound | Day 3 | Day 5 | Day 7 | Day 9 | Day 11 |
|---|---|---|---|---|---|---|---|
| Milo whole stillage | Mx | Astaxanthin | 0.42 ± 0.09 | 2.0 ± 0.22 | 4.91 ± 0.19 | 6.48 ± 0.41 | 6.61 ± 0.52 |
| | | β-Carotene | 34.9 ± 2.68 | 62.66 ± 0.42 | 159.74 ± 4.42 | 169.49 ± 1.49 | 254.82 ± 2.84 |
| | PR | Astaxanthin | 3.64 ± 0.44 | 7.21 ± 2.05 | 14.8 ± 0.36 | 22.12 ± 1.66 | 28.2 ± 0.89 |
| | | β-Carotene | 5.55 ± 0.38 | 43.62 ± 4.18 | 72.49 ± 0.51 | 85.21 ± 1.21 | 138.03 ± 3.52 |
| | SR | β-Carotene | 44.2 ± 1.08 | 95.95 ± 6.04 | 190.21 ± 2.0 | 196.39 ± 5.25 | 199.96 ± 1.85 |
| Full-fat rice bran | Mx | Astaxanthin | n.d. | 1.69 ± 0.52 | 2.79 ± 0.31 | 2.97 ± 0.78 | 3.25 ± 0.45 |
| | | β-Carotene | 81.65 ± 1.93 | 124.81 ± 12.87 | 226.28 ± 9.2 | 232.24 ± 3.89 | 282.43 ± 13.27 |
| | PR | Astaxanthin | 6.12 ± 0.6 | 15.69 ± 1.98 | 34.09 ± 1.93 | 52.47 ± 4.98 | 80.42 ± 16.33 |
| | | β-Carotene | 62.56 ± 0.5 | 58.94 ± 4.64 | 107.45 ± 6.19 | 149.61 ± 10.36 | 149.53 ± 27.74 |
| | SR | β-Carotene | n.d. | 68.4 ± 5.98 | 119.92 ± 14.25 | 128.92 | 196.0 ± 11.47 |
| Defatted rice bran | Mx | Astaxanthin | 1.61 ± 0.67 | 2.45 ± 0.82 | 11.77 ± 9.17 | 3.09 ± 0.62 | 2.42 ± 0.28 |
| | | β-Carotene | 71.1 ± 0.34 | 104.36 ± 4.41 | 132.71 ± 15.87 | 156.82 ± 11 | 132.67 ± 25.83 |
| | PR | Astaxanthin | 2.0 ± 0.55 | 14.86 ± 1.29 | 16.67 ± 2.21 | 20.84 ± 1.1 | 16.94 ± 2.65 |
| | | β-Carotene | n.d. | 29.0 ± 1.72 | 47.59 ± 3.09 | 53.54 ± 2.11 | 37.26 ± 1.11 |
| | SR | β-Carotene | n.d. | 38.07 ± 7.12 | 66.21 ± 1.56 | 236.15 ± 19.95 | 80.46 ± 14.2 |
| Full-fat soy flour | Mx | Astaxanthin | 2.61 ± 0.01 | 3.04 ± 0.06 | 4.3 ± 0.3 | 4.48 ± 0.19 | 3.55 ± 0.035 |
| | | β-Carotene | 157.48 ± 0.4 | 422.59 ± 1.72 | 753.32 ± 15.29 | 809.91 ± 4.69 | 753.62 ± 0.89 |
| | PR | Astaxanthin | 5.73 ± 0.01 | 12.84 ± 0.16 | 20.37 ± 0.03 | 38.14 ± 0.3 | 46.0 ± 0.2 |
| | | β-Carotene | 12.89 ± 1.2 | 68.72 ± 1.36 | 36.83 ± 3.6 | 118.99 ± 0.69 | 126.01 ± 1.55 |
| | SR | β-Carotene | 142.43 ± 2.22 | 377.31 ± 1.29 | 625.0 ± 3.79 | 727.31 ± 3.97 | 836.55 ± 6.61 |
| Defatted soy flour | Mx | Astaxanthin | 2.95 ± 0.15 | 6.66 ± 0.06 | 10.44 ± 0.06 | 11.61 ± 0 | 11.48 ± 0.18 |
| | | β-Carotene | 103.2 ± 2.58 | 165.35 ± 0.55 | 394.72 ± 3.33 | 449.63 ± 0.73 | 402.55 ± 1.76 |
| | PR | Astaxanthin | 5.08 ± 0.03 | 8.34 ± 0.09 | 17.53 ± 1.2 | 27.61 ± 0.23 | 36.55 ± 0.35 |
| | | β-Carotene | n.d. | 72.0 ± 0.86 | 128.27 ± 2.28 | 144.01 ± 0.27 | 161.64 ± 1.52 |
| | SR | β-Carotene | 108.53 ± 2.23 | 174.06 ± 0.34 | 372.46 ± 4.61 | 428.67 ± 1.2 | 532.58 ± 4.21 |
| Soy meal | Mx | Astaxanthin | 1.63 ± 0.09 | 2.84 ± 0.01 | 5.36 ± 0.12 | 5.81 ± 0.1 | 8.58 ± 0.03 |
| | | β-Carotene | 103.46 ± 1.29 | 139.94 ± 0.01 | 371.16 ± 1.37 | 392.4 ± 0.27 | 433.9 ± 1.36 |
| | PR | Astaxanthin | 5.9 ± 0.28 | 5.94 ± 0.03 | 15.73 ± 0.05 | 20.52 ± 0.07 | 30.98 ± 0.19 |
| | | β-Carotene | n.d. | 68.12 ± 0.37 | 112.78 ± 0.62 | 123.32 ± 0.5 | 135.62 ± 0.07 |
| | SR | β-Carotene | 120.81 ± 0.69 | 158.94 | 289.51 ± 0.23 | 434.17 ± 6.75 | 462.76 ± 1.39 |
| Soy hull | Mx | Astaxanthin | n.d. | n.d. | n.d. | n.d. | n.d. |
| | | β-Carotene | n.d. | 1.4 ± 0.9 | 4.8 ± 0.99 | 10.56 ± 1.22 | 12.05 ± 1.25 |
| | PR | Astaxanthin | n.d. | 2.6 ± 0.25 | 2.78 ± 0.11 | 4.07 ± 1.16 | 5.22 ± 0.36 |
| | | β-Carotene | n.d. | 18.29 ± 3.23 | 25.04 ± 10.34 | 27.92 ± 7.3 | 34.46 ± 6.24 |
| | SR | β-Carotene | n.d. | n.d. | n.d. | n.d. | n.d. |
| Wheat bran | Mx | Astaxanthin | 1.88 ± 0.69 | 2.92 ± 1.23 | 3.6 ± 1.42 | 4.67 | 7.42 ± 1.29 |
| | | β-Carotene | 57.16 ± 7.64 | 87.97 ± 16.68 | 145.0 ± 6.83 | 140.29 ± 3.58 | 159.58 ± 2.68 |
| | PR | Astaxanthin | 4.54 ± 0.76 | 9.4 ± 1.64 | 15.36 ± 1.95 | 25.31 ± 6.22 | 66.75 ± 8.21 |
| | | β-Carotene | n.d. | 38.02 ± 7.8 | 43.04 ± 12.31 | 64.65 ± 4.2 | 78.91 ± 6.45 |
| | SR | β-Carotene | n.d. | 70.46 ± 29.13 | 122.79 ± 9.12 | 143.94 ± 18.16 | 198.39 ± 8.41 |

^{a}Carotenoid yield expressed as μg/g of media. Means and standard error expressed: n.d. = nondeterminable. Highest yield per treatment is boldfaced.
^{b}Mx = mixed culture; PR = Phaffia rhodozyma; and SR = Sporobolomyces roseus.

Residual glycerol at each time point varied within yeast treatments for each substrate (see, Table 2). For example, by day 5, all the glycerol was consumed by the mixed culture in wheat bran, but much of it remained in soy hull. For most treatments, there was a significant negative correlation between residual glycerol and carotenoids, which suggests that more carotenoids were synthesized as the yeasts consumed more glycerol (see, Table 3). There was a low correlation between glycerol and carotenoid production for all treatments on defatted rice bran and soy hull and for the mixed culture on wheat bran. In defatted rice bran, unlike other substrates, the carotenoid production peaked on day 7 or 9 and then had a decreasing trend, whereas in soy hull the different fungal treatments did not utilize glycerol effectively, resulting in low correlation. However, in wheat bran mixed culture fermentation, glycerol was utilized rapidly so that by day 5 there was no residual glycerol, resulting in low correlation between glycerol and carotenoids. Except for defatted rice bran, where the highest yields of both carotenoids were on day 9 of fermentation, all other substrates showed highest yields on day 11.

TABLE 2
Residual Glycerol on Different Substrates Resulting from Red Yeast Fermentation

| Substrate | Fungus^{b} | Day 3 | Day 5 | Day 7 | Day 9 | Day 11 |
|---|---|---|---|---|---|---|
| Milo whole stillage | Mx | 25.44 ± 0.71 | 25.23 ± 0.15 | 1.2 ± 0.79 | n.d. | n.d. |
| | PR | 35.06 ± 0.04 | 27.8 ± 0.34 | 18.92 ± 0.75 | 16.59 ± 1.26 | n.d. |
| | SR | 26.87 ± 0.69 | 15.27 ± 0.685 | 0.27 ± 0.1 | n.d. | n.d. |
| Full-fat rice bran | Mx | 19.62 ± 0.29 | 6.45 ± 1.95 | n.d. | n.d. | n.d. |
| | PR | 22.41 ± 1.09 | 13.45 ± 0.77 | 0.47 ± 0.27 | 0.28 ± 0.12 | n.d. |
| | SR | 19.79 | 10.2 | 2.1 | 0.09 ± 0.06 | n.d. |
| Defatted rice bran | Mx | 26.87 ± 0 | 4.37 ± 1.2 | 0.09 ± 025 | n.d. | n.d. |
| | PR | 34.16 ± 0 | 31.2 ± 0 | 28.41 ± 1.86 | 24.62 ± 1.62 | 23.4 ± 0.48 |
| | SR | 25.24 ± 2.61 | 2.24 ± 0 | 0.89 ± 0.45 | 0.37 ± 0.2 | n.d. |
| Full-fat soy flour | Mx | 18.65 ± 0.57 | 1.02 ± 0.24 | n.d. | n.d. | n.d. |
| | PR | 33.45 ± 0.14 | 18.54 ± 0.12 | 8.08 ± 0.26 | 0.33 ± 0.12 | n.d. |
| | SR | 23.60 ± 0.46 | 0.64 ± 0.07 | n.d. | n.d. | n.d. |
| Defatted soy flour | Mx | 15.21 ± 0.42 | 4.44 ± 0.75 | n.d. | n.d. | n.d. |
| | PR | 34.98 ± 0.49 | 33.19 ± 0.19 | 28.25 ± 0.84 | 19.14 ± 0.9 | 6.15 ± 1.15 |
| | SR | 17.12 ± 0.26 | 1.38 ± 0.11 | 0.32 ± 0.09 | n.d. | n.d. |
| Soy meal | Mx | 15.46 ± 0.25 | 3.94 ± 0.71 | n.d. | n.d. | n.d. |
| | PR | 38.41 ± 0.29 | 33.98 ± 0.04 | 21.96 ± 0.28 | 16.86 ± 0.14 | 4.32 ± 0.10 |
| | SR | 22.85 ± 0.29 | 5.51 ± 0.18 | n.d. | n.d. | n.d. |
| Soy hull | Mx | 23.33 | 18.77 ± 3.65 | 10.01 | 4.11 ± 3.61 | 1.01 ± 0.84 |
| | PR | 37.75 ± 7.73 | 35.09 ± 0.85 | 34.34 ± 1.29 | 31.8 ± 1.19 | 29.19 ± 2.83 |
| | SR | 18.5 | 15.72 ± 2.34 | 12.4 ± 0.59 | 4.0 ± 0.5 | 0.84 ± 0.43 |
| Wheat bran | Mx | 13 ± 1.54 | n.d. | n.d. | n.d. | n.d. |
| | PR | 34.55 ± 0.55 | 33.39 ± 4.44 | 23.71 ± 0.12 | 14.53 ± 0.04 | n.d. |
| | SR | 20.62 ± 1.54 | 0.765 ± 0.26 | 0.59 ± 0.5 | 0.38 ± 0.3 | n.d. |

^{a}Glycerol expressed as mg/g of media. Means and standard error expressed; n.d. = nondeterminable.
^{b}Mx = mixed culture; PR = Phaffia rhodozyma; and SR = Sporobolomyces roseus

TABLE 3
Correlation of Glycerol Utilization and Carotenoid Production

| | | Astaxanthin | β-Carotene |
|---|---|---|---|
| Substrate | Fermentation^{b} | r | r |
| Milo whole stillage | Mx | −0.675* | −0.869* |
| | PR | −0.96*** | −0.96*** |
| | SR | . . . | −0.675* |
| Full-fat rice bran | Mx | −0.909** | −0.876** |
| | PR | −0.912** | −0.761* |
| | SR | . . . | −0.63ns |
| Defatted rice bran | Mx | −0.054ns | −0.588ns |
| | PR | −0.238ns | −0.588ns |
| | SR | . . . | −0.468ns |
| Full-fat soy flour | Mx | −0.887** | −0.86** |
| | PR | −0.984*** | −0.829** |
| | SR | . . . | −0.87** |
| Defatted soy flour | Mx | −0.89** | −0.87** |
| | PR | −0.98*** | −0.98*** |
| | SR | . . . | −0.75* |
| Soy meal | Mx | −0.88** | −0.88** |
| | PR | −0.951*** | −0.88** |
| | SR | . . . | −0.87** |
| Soy hull | Mx | . . . | 0.058ns |
| | PR | 0.389ns | −0.276ns |
| | SR | . . . | . . . |
| Wheat bran | Mx | −0.547ns | −0.38ns |
| | PR | −0.936*** | −0.927** |
| | SR | . . . | −0.77* |

^{a} *, **, and *** indicate P < 0.05, 0.01, and 0.0001, respectively; ns = not significant.
^{b}Mx = mixed culture; PR = Phaffia rhodozyma; and SR = Sporobolomyces roseus.

In this study, carotenoid enrichment of commonly used animal feeds, namely milo whole stillage, rice bran, soy flour, soy meal, soy hull, and wheat bran by fermentation of red yeasts was carried out. Astaxanthin yields of P. rhodozyma and mixed-culture fermentation varied depending on the substrate and were 0-80 μg/g and 0-17 μg/g, respectively, and β-carotene yields of P. rhodozyma, S. roseus, and the mixed culture were 34-162 μg/g, 0-837 μg/g, and 12-282 μg/g, respectively, confirming that the carbon source in the medium influences carotenoid production.

Additionally, based upon the relevant literature, the fat content of the fermentation media is thought to influence carotenoid production. However, it was discovered that fat content of each substrate is unlikely to be the only factor influencing the β-carotene production in red yeasts. For example, in the case of S. roseus fermentation, defatted soy flour, soy meal, defatted rice bran, and soy hull contained around 2% fat, yet their β-carotene levels were 533, 463, 236, and 0 μg/g, respectively; wheat bran, which contained around 4% fat, yielded only 198 μg of β-carotene per gram; full-fat soy flour and rice bran contain around 21% fat, yet the β-carotene production was 837 and 196 μg/g, respectively. Surprisingly, astaxanthin yields in P. rhodozyma fermentation in full-fat rice bran and soy flour were 80 and 46 μg/g, respectively. Protein levels of the substrates did not suggest any trend regarding carotenoid production.

In this study, P. rhodozyma and S. roseus used glycerol as a carbon source for carotenoid production. Overall, rice bran and full-fat soy flour were the best substrates for astaxanthin and β-carotene production. The mixed cultures tended to yield the highest amount of total carotenoids. For example, mixed-culture fermentation of rice bran and milo whole stillage produced higher β-carotene yields than the respective monocultures. Although mixed-culture fermentation has enhanced carotenoid production or ensured effective substrate utilization or both, the specific carotenoid-triggering mechanism is unknown. It is believed that some of the biochemical intermediates of red yeasts may serve as precursors in carotenoid-producing microbes. Because substrates also seem to influence carotenoid production, as seen in this contribution, enhanced β-carotene production in the mixed culture in some cases may result from complex interaction of substrate nutrients and biochemical intermediates produced by the red yeasts.

The nutritional profile of full-fat soy flour (FFSF) and carotenoid-enriched FFSF was investigated to determine effects that fermentation by red yeasts might have on the levels of other nutrients. These results are given in Table 4.

TABLE 4
Nutrition profile of full fat soy flour
(FFSF) and carotenoid-enriched FFSF

| Com- | | Mixed | P. | |
|---|---|---|---|---|
| ponents ^{a} | Control | culture | rhodozyma | S. roseus |
| % Crude | 35.81 | 30.98 | 22.87 | 30.95 |
| Protein | | (↓13.5%) | (↓36%) | (↓13.5%) |
| % Crude | 16.26 | 14.29 | 9.67 | 14.1 |
| Fat ^{c} | | (↓12%) | (↓40.5%) | (↓13%) |
| % Crude | 5.23 | 4.87 | 3.34 | 4.59 |
| fiber | | (↓7%) | (↓36%) | (↓12%) |
| % NDF | 9.72 | 10.49 | 7.3 | 10.34 |
| | | (↑8%) | (↓25%) | (↑6%) |
| % ADF | 5.79 | 7.44 | 2.64 | 5.18 |
| | | (↑28.5%) | (↓54%) | (↓10.5%) |
| % N | 5.7 | 5.0 | 3.7 | 5.0 |
| | | (↓12%) | (↓35%) | (↓12%) |
| % P | 0.45 | 0.56 | 0.4 | 0.56 |
| | | (↑24%) | (↓11%) | (↑24%) |
| % K | 1.64 | 1.55 | 1.19 | 1.54 |
| | | (↓5.5%) | (↓27%) | (↓6%) |
| % Mannan | — | 3.23 | 1.01 | 2.38 |
| % Glucann | — | 3.52 | 2.43 | 2.48 |
| % Glucos- | — | 0.3 | 1.96 | 4.61 |
| amine | | | | |
| Trypsin | 49,500 ^{d} | 1,456 | n.d | n.d |
| Inhibitor | 7,550 ^{e} | (↓97%) ^{f} | | |
| (TIU/g) | | | | |
| Astaxanthin | 0.00 | 3.55 | 46 | — |
| (μg/g) | | | | |
| (β-carotene | 0.00 | 753.6 | 126.01 | 836.5 |
| (μg/g) | | | | |

^{a} Means and standard deviation are provided; Numbers in parentheses indicate the % increase (↑) or decrease (↓) compared to the control; Maximum increase or decrease is boldfaced
^{b} Kjeldahl
^{c} Acid hydrolysis
^{d} Trypsine inhibitor in unautoclaved control sample of full fat soy flour
^{e} Trypsine inhibitor in autoclaved control sample of full fat soy flour
^{f} % reduction compared to autoclaved control sample

As can be seen from the profiles, carotenoid fermentation by mixed culture red yeasts reduced trypsin inhibitor, an anti-nutritional compound present in soybean animal feeds, by 97%. Further, red yeasts were shown to provide glucanns, mannans, and glucosamine, which are important animal feed nutrients.

### Example 3

In this example, the preparation of carotenoid-rich animal feeds from corn whole stillage was examined using secondary fermentation processes. Lyophilized cultures of Phaffia rhodozyma (ATCC 24202) and Sporobolomyces roseus (ATCC 28988) were obtained from the American Type Culture Collection (ATCC, Manassas, Va., USA), revived on yeast extract malt extract agar (YMA), and incubated at 18° C. for 10 days. After revival, cultures were inoculated into yeast extract malt extract broth (YMB) and incubated at 18° C. on an orbital shaker at 180 rpm for 5 days. Cultures were then inoculated on YMA slants, incubated for 10 days, and later stored at −80° C. for long-term preservation. Additionally, yeast cells from YMB were centrifuged and resuspended in 20% glycerol and stored at −80° C. in one ml aliquots. For routine experiments, freshly prepared slants were used. Phaffia rhodozyma ATCC 24202 is a known carotenoid producer and has xylose-metabolizing ability.

From each fungal strain, a loopful of cells from respective slants was inoculated into sterile 100 ml YMB in 500 ml flasks. Flasks were incubated at 18° C. and 180 rpm for 72 h. The development of orange and red color in P. rhodozyma and S. roseus flasks, respectively, indicated good fungal growth. A 10% (v/v) inoculum was used for monoculture fermentation, while 5% of each strain was used in mixed culture fermentation.

Corn whole stillage was procured from Abengoa Bioenergy (Colwich, Kans., USA). Apart from whole stillage, the medium comprised glycerol and corn steep liquor. The supplementation with glycerol and corn steep liquor was considered necessary, as (1) whole stillage is poor in readily utilizable sugars, and the addition of glycerol and corn steep liquor provides readily available carbon and reduces the lag phase, (2) glycerol can act as a carbon source for astaxanthin production by P. rhodozyma, (3) carotenoid production is increased by the balanced and increased formation of acetyl CoA, pyruvate and glyceraldehyde-3-phosphate, all of which can be produced by the glycolysis of glycerol, and (4) glycerol is a cheap and abundantly produced co-product of the biodiesel and soap industry, and was found to be an effective supplement for β-carotene production by B. trispora.

Initially, a liter of the fermentation medium contained 25% whole stillage, 2% corn steep liquor, 5% glycerol and minerals: 1 g KH₂PO₄, 0.5 g MgSO₄, 0.5 g MnSO₄ and 0.5 g ZnSO₄. However, the medium later was optimized using response surface methodology to contain (per liter) 15% whole stillage, 1.5% corn steep liquor, 7.7% glycerol and mineral salts (0.6 g KH₇PO₄, 0.3 g MgSO₄, 0.3 g MnSO₄ and 0.7 g ZnSO₄). The current study utilized only P. rhodozyma monoculture for optimization of the fermentation medium. In both cases, the media pH was about 6.0 before sterilization and was not adjusted any further. Flasks with 50 ml of whole stillage medium were sterilized at 121° C. for 30 min.

Submerged fermentations of P. rhodozyma and S. roseus mono- and mixed cultures were conducted. Flasks were inoculated and incubated at 18° C., 180 rpm for 9 days. Control flasks without inocula were maintained. Samples were harvested on days 5, 7, and 9 of fermentation, centrifuged, and the supernatant was discarded. Pellets were freeze-dried for 24 h and stored at −80° C. until further analysis. Two replicates per treatment were employed.

A known amount of freeze-dried sample was weighed into a mortar, 0.2 g of acid-washed sand (40-100 mesh size) was added, and carotenoids were extracted by grinding the mixture in dichloromethane solvent. Samples were centrifuged at 5,000 rpm for 5 min and the supernatant was filtered into 1.5 ml HPLC vials using 0.2 μm filters.

High-performance liquid chromatography (HPLC) was used to quantify carotenoids. Astaxanthin and β-carotene standards were obtained from Sigma-Aldrich (St Louis, Mo., USA). A Shimadzu HPLC equipped with an LC-20AB pump, a SIL-20AC autosampler, an SPD-M20A PDA detector and a CTO-20A column oven was used. A Phenomenex Prodigy C18 column (150 mm length and 4.6 mm internal diameter) along with a C18 guard column were used to separate carotenoids. Acetonitrile:methanol (80:20) were used as the mobile phase. Flow rate was maintained at 2.0 ml/min and the column was maintained at 40° C. About 20 μl of the sample were injected using the autosampler. HPLC data were acquired using Lab Solutions software. Carotenoid yield was expressed as μg/g of freeze-dried whole stillage sample instead of yield per gram of yeast dry weight, as it was not possible to separate yeast cells from the whole stillage solids. Total carotenoids were calculated as the sum of astaxanthin and β-carotene yields.

Identification of purified carotenoids was carried out by MALDI/TOF MS (using a Bruker Ultraflex II TOF/TOF mass spectrometer) and proton NMR (on a Varian Inova, 400 MHZ). Data before and after validation were analyzed using SAS (version 9.1.3). PROC GLM was used to compare multiple treatments, and (when necessary) pair-wise comparisons were made using Tukey-Kramer at P=0.05. Optimization data were analyzed by Design Expert 7.1.6.

Both P. rhodozyma monoculture and mixed culture fermentations produced whole stillage enriched in astaxanthin and β-carotene, while S. roseus monoculture produced only β-carotene-enriched whole stillage. The production profile of astaxanthin and β-carotene before optimization is provided in Table 5. The astaxanthin yields on days 5, 7, and 9 of fermentation by P. rhodozyma and mixed culture, respectively, showed an increasing trend. Astaxanthin yield in P. rhodozyma fermentation did not vary over time, but the mixed culture fermentation yield on day 9 was significantly greater than those on days 5 and 7. β-Carotene yields in all three treatments showed an increasing trend: S. roseus yields on days 5, 7, and 9 were significantly different from each other, P. rhodozyma did not vary significantly, and the yield from the mixed culture fermentation was the greatest on day 9 and significantly different from those on days 5 and 7.

TABLE 5
Carotenoid yields (μg/g of freeze-dried
whole stillage) from unoptimized medium

| | Treat- | | | |
|---|---|---|---|---|
| Carotenoids^{a} | ment^{b} | Day 5 | Day 7 | Day 9 |
| Astaxanthin | Mx | 11.26 ± 0.8^{B} | 12.59 ± 0.49^{B} | 17.41 ± 0.17^{A} |
| | PR | 25.95 ± 2.9 | 31.21 ± 0.99 | 35.73 ± 1.64 |
| | SR | — | — | — |
| β-Carotene | Mx | 135.58 ± 5.12^{B} | 135.92 ± 3.74^{B} | 187.89 ± 0.6^{A} |
| | PR | 76.28 ± 8.95 | 89.92 ± 4.48 | 104.72 ± 4.96 |
| | SR | 149.97 ± 1.34^{C} | 192.72 ± 4.98^{B} | 232.99 ± 2.55^{A} |
| Total | Mx | 146.84^{B} | 148.51^{B} | 205.3^{A} |
| | PR | 102.33 | 121.13 | 140.45 |
| | SR | — | — | — |

^{a}Means and standard errors are provided; significance was set at P ≦ 0.05. ANOVA: astaxanthin: Mx-F = 33.0, P = 0.0091; PR-F = 5.89, P = 0.0914; β-carotene: Mx-F = 66.85, P = 0.0033; PR-F = 4.86, P = 0.1145; SR-F = 155.67, P = 0.0009; total carotenoids: Mx-F = 89.73, P = 0.0021; PR-F = 5.11, P = 0.1082; significantly different treatments across days do not share a letter (uppercase)
^{b}Mx mixed culture, PR P. rhodozyma, SR S. roseus

The astaxanthin and β-carotene yields from mono- and mixed culture fermentations of optimized medium are provided in Table 6. The astaxanthin and n-carotene yields from P. rhodozyma on day 7 were 67 and 265 μg/g, respectively. Media optimization improved P. rhodozyma astaxanthin yield by 119% and β-carotene yield by 197% on day 7. Astaxanthin yield in P. rhodozyma increased by 177% on day 9, confirming the enhanced astaxanthin production in the late log phase or exponential phase. Although the optimized conditions of P. rhodozyma were applied to the S. roseus monoculture and mixed culture fermentations, only a marginal increase in carotenoid production was observed, except in the astaxanthin yield of the mixed culture, where a yield reduction of 71% was observed. This indicates that S. roseus monoculture and mixed culture fermentations require independent optimization.

TABLE 6
Carotenoid Yields (μg/g of freeze-dried whole stillage) from optimized medium

| Carotenoids^{a} | Treatment^{b} | Day 5 | | Day 7 | | Day 9 | |
|---|---|---|---|---|---|---|---|
| Astaxanthin | Mx | 5.91 ± 0.93 | (−54%)^{c} | 5.076 ± 0.33 | (−58%) | 5.08 ± 0.31 | (−71%) |
| | PR | 47.86 ± 2.07^{C} | (88%) | 67.77 ± 4.22^{B} | (116%) | 97.71 ± 1.59^{A} | (177%) |
| | SR | — | | — | | — | |
| β-Carotene | Mx | 212.47 ± 8.04^{B} | (57%) | 244.96 ± 15.01^{AB} | (80%) | 278.86 ± 9.65^{A} | (48%) |
| | PR | 241.83 ± 2.97 | (217%) | 265.77 ± 23.63 | (197%) | 275.20 ± 16.38 | (164%) |
| | SR | 243.39 ± 6.28 | (63%) | 237.52 ± 9.95 | (23%) | 278.58 ± 28.00 | (20%) |
| Total | Mx | 218.38 ± 8.32^{B} | (48%) | 250.03 ± 15.34^{AB} | (68%) | 283.94 ± 9.36^{A} | (38%) |
| | PR | 289.69 ± 4.89^{B} | (183%) | 333.53 ± 27.65^{AB} | (175%) | 372.91 ± 15.63^{A} | (165%) |

| | | | |
|---|---|---|---|
| SR | — | — | — |

^{a}Means and standard errors are provided; significance was set at P ≦ 0.05. ANOVA: astaxanthin: Mx-F = 0.64, P = 0.5578; PR-F = 76.6, P = <0.0001; β-carotene: Mx-F = 8.63, P = 0.0172; PR-F = 1.06, P = 0.4025, SR-F = 1.60, P = 0.2768; total carotenoids: Mx-F = 8.22, P = 0.0191; PR-F = 5.04, P = 0.052; significantly different treatments across days do not share a letter (uppercase)
^{b}Mx mixed culture, PR P. rhodozyma, SR S. roseus
^{c}% in parentheses is the percentage increase (or decrease) in the yield compared to that from unoptimized medium (Table 4)

This study demonstrated the successful production of visually appealing carotenoid-enriched whole stillage that is rich in both astaxanthin and β-carotene (the carotenoid-rich samples exhibited an orange color versus the green appearance of the freeze-dried whole stillage). Since the carotenoid levels in carotenoid-enriched whole stillage were in the range that is generally used in animal feed, carotenoid-enriched DDGS produced by secondary fermentation with carotenoid-producing yeasts has a potential application as a “value-added animal feed.”

The maximum astaxanthin yield by P. rhodozyma upon optimization was 97 μg/g of freeze-dried sample. The S. roseus strain used in this study predominantly produced β-carotene, and the maximum yield was about 278 μg/g of freeze-dried whole stillage. Astaxanthin usually accounts for 80-90% or even 100% of the total carotenoids of P. rhodozyma. However, under microaerophilic conditions, β-carotene is accumulated at the expense of astaxanthin. In this study, β-carotene production by P. rhodozyma accounted for 75% of its total carotenoids, indicating that the medium was probably microaerophilic. The macro ingredients probably increased the medium's viscosity, leading to lesser diffusion of oxygen. This is indirectly supported by the RSM model, which suggested that decreasing the concentration of macro ingredients leads to higher carotenoid production. In mixed culture fermentation, the β-carotene yield was comparable to that of P. rhodozyma and S. roseus, and was not cumulative compared to those of the two strains.

Astaxanthin and β-carotene constitute the total carotenoid pool in this study. However, S. roseus produces other carotenoids such as torulene and torularhodin. Similarly, P. rhodozyma is also known to produce torulene and torularhodin. While the carotenoid-enriched whole stillage was not evaluated for these additional carotenoids, it is likely that they are produced by both the P. rhodozyma and the S. roseus strains. The total carotenoid content in the value-added DDGS will be further enhanced if these carotenoids are accounted for.

Overall, the optimization studies indicate that, in shake flasks, lower concentrations of whole stillage, glycerol and corn steep liquor improve the carotenoid yield. The optimized medium had 40% less whole stillage, 25% less corn steep liquor and 54% more glycerol. The results indirectly confirm that carotenoid production, especially astaxanthin production, is influenced by aeration. As the medium viscosity increases, the amount of dissolved oxygen is reduced, severely affecting astaxanthin production. The glycerol concentration was increased as it was shown to positively influence the β-carotene production. It is likely that reducing the amount of glycerol would further increase astaxanthin production, but it could also negatively influence β-carotene production.

The stability of the carotenoids produced in the enriched DDGS was analyzed, as it is important that animal feed materials exhibit some shelf stability. As shown in Table 7, dried samples of carotenoid-enriched DDGS from shake flasks were stored at four temperatures namely, room temperature, 4, −20 and −80° C. Samples were subjected to HPLC estimation on a monthly basis for six months to determine the stability of carotenoids. Carotenoids in the samples were stable for a period of six months and storage temperature did not affect their stability.

TABLE 7
Evaluation of product stability

| | | Mx | | PR | | |
|---|---|---|---|---|---|---|
| | Temp^{a} | Asta- | β- | Asta- | | SR |
| Months | ° C. | xanthin | carotene | xanthin | β-carotene | β-carotene |
| September | | 4.87 | 282 | 98.3 | 278 | 285 |
| October | RT | 5.02 | 276 | 96 | 275.11 | 276.09 |
| | 4 | 4.95 | 279.1 | 96.1 | 276.19 | 269 |
| | −20 | 4.94 | 288.62 | 98.7 | 278.41 | 288.11 |
| | −80 | 5.01 | 283 | 98.4 | 276 | 288.97 |
| November | RT | 4.91 | 268.41 | 97.1 | 261 | 268.99 |
| | 4 | 4.99 | 272.04 | 97.41 | 268.21 | 256.41 |
| | −20 | 5.25 | 287.68 | 97.62 | 279.58 | 286.52 |
| | −80 | 4.88 | 284.66 | 99.12 | 282.11 | 284.62 |
| December | RT | 4.01 | 256.58 | 94.22 | 246 | 254.33 |
| | 4 | 4.22 | 267.55 | 96.41 | 255.13 | 253.88 |
| | −20 | 4.87 | 286.09 | 96.98 | 273.14 | 286.77 |
| | −80 | 5.01 | 284.67 | 98.11 | 279.33 | 292.11 |
| January | RT | 4.77 | 251.27 | 95.26 | 243.58 | 241.08 |
| | 4 | 4.51 | 255.45 | 95.22 | 256.36 | 248.08 |
| | −20 | 4.92 | 282.34 | 97.41 | 281 | 283.41 |
| | −80 | 4.77 | 284 | 98.19 | 276.45 | 289.06 |
| February | RT | 4.21 | 247.97 | 94.99 | 246.66 | — |
| | 4 | 4.39 | 250.97 | 95.27 | 251 | — |
| | −20 | 5.01 | 279.64 | 95.21 | 276 | — |
| | −80 | 4.96 | 285.61 | 98.67 | 277.28 | — |
| March | | | | | | — |
| | RT | 4.23 | 247.14 | 93.59 | 239.55 | — |
| | 4 | 4.5 | 245.22 | 95.82 | 241 | — |
| | −20 | 4.94 | 277.55 | 97.11 | 277 | — |
| | −80 | 5.06 | 287.66 | 97.28 | 281.01 | — |

^{a}RT—room temperature: — sample insufficient for analysis; carotenoids μg/g

### Example 4

In this example, carotenoid-enriched DDGS were produced in a 2 L bench-top fermenter. The nutritional composition of the carotenoid-enriched DDGS was evaluated and compared between monoculture and mixed culture fermentation and control DDGS.

Lyophilized cultures of Phaffia rhodozyma (ATCC 24202) and Sporobolomyces roseus (ATCC 28988) were obtained form American Type Culture Collection (ATCC, Manassas, Va.). A 10% (v/v) inoculum was used for monoculture fermentation, while 5% of each strain was used in mixed culture fermentation. A liter of the fermentation medium contained 15% whole stillage, 1.5% corn steep liquor, 7.7% glycerol and mineral salts (0.6 g of KH₂PO₄, 0.3 g of MgSO₄, 0.3 g of MnSO₄ and 0.7 g of ZnSO₄). Corn whole stillage was procured from Abengoa Bioenergy (Colwich, Kans., USA). Media pH was about 6.0 before sterilization and was not adjusted any further.

Fermentation was carried out using a 2 L BBraun Biostat-B fermenter. About 1.5 L of the fermentation medium was sterilized in the fermenter at 121° C. for 30 min. Batch fermentation was carried out for seven days at 20° C., 500 rpm and 1% (v/v) sterile air. Dissolved oxygen and pH were monitored for every 2 h. Three fermenter runs, one each for P. rhodozyma and S. roseus monocultures, and mixed culture fermentation were carried out. The entire fermentation broth was harvested on day 7, aliquoted into five bottles and freeze-dried for five days. After freeze-drying, samples were pooled and blended using a coffee blender. Samples were stored at −20° C. until further analyses. The control sample contained all the media ingredients except glycerol. Two representative samples from each treatment were subjected to nutritional profiling. It is known that whole stillage and/or DDGS samples from different batches from the same ethanol plant can have variations in their nutritional composition. This can potentially affect the carotenoid production. However, multiple fermenter runs were not possible due to limited whole stillage sample.

Carotenoids were extracted in dichloromethane solvent by grinding a known amount of freeze-dried sample with 0.2 g of acid washed sand (40-100 mesh size). High performance liquid chromatography (HPLC) was used for quantification of carotenoids. Astaxanthin and β-carotene standards were obtained from Sigma Aldrich (St. Louis, Mo., USA). A Shimadzu HPLC equipped with LC-20AB pump, SIL-20AC auto sampler, SPD-M20A PDA detector and CTO-20A column oven was used. Phenomenex Prodigy C18 column (150 mm length and 4.6 mm internal diameter) along with a C18 guard column was used for the separation of carotenoids. An acetonitrile and methanol (80:20) mobile phase was used. The carotenoid yield was expressed as μg/g of freeze-dried whole stillage sample instead of yield per gram of yeast dry weight as it was impossible to separate yeast cells from the whole stillage solids.

Nutrition composition analyses of the samples were conducted to include total amino acid profile, total fatty acid profile, crude fat and protein, crude fiber, % NDF, % ADF, % P, % S, and % K. About 10 g of each representative sample from each treatment was analyzed at Agricultural Experiment Station Chemical Laboratories, University of Missouri (Columbia, Mo.) for total amino acid profile (AOAC Official Method 982.30E (a, b, c), chapter 45.3.05), total fatty acid profile (AOAC Official Method 996.06, AOCS Official Method Ce 2-66, AOAC Official Method 965.49, AOAC Official Method 969.33), crude fat (acid hydrolysis, AOAC Official Method 954.02), and protein (Kjeldahl method, AOAC Official Method 984.13 (A-D)). Estimation of % P, K, S and crude fiber, % NDF and % ADF was conducted at Analytical Laboratory, Department of Animal Science and Industry, Kansas State University (Manhattan, Kans.).

The crude composition of DDGS and the secondary fermented products are presented in Table 8. Compared to the control, P. rhodozyma, S. roseus and mixed culture fermentation resulted in lesser protein, amino acids, N, and fiber, and enhanced fat. Maximum reduction in percent protein, fiber and N was seen in P. rhodozyma, and the best fat enhancement was seen in mixed culture fermentation. Fiber reduction by yeast fermentations ranged from 63 to 77%. Percent P, K, and S were not reduced drastically compared to the control. However, S. roseus reduced % P and % K by 17% and 14%, respectively, and P. rhodozyma reduced % S by 15%.

TABLE 8
Nutrition Profile of DDGS and Carotenoid-Enriched DDGS

| components^{a} | control | mixed culture | | P. rhodozyma | | S. roseus | |
|---|---|---|---|---|---|---|---|
| % crude protein^{b} | 27.77 ± 0.24 | 17.16 ± 0.11 | (↓38%) | 12.95 ± 0.064 | (↓53%) | 17.75 ± 0.05 | (↓36%) |
| % crude fat^{c} | 14.59 ± 0.1 | 26.35 ± 0.1 | (↑81%) | 17.07 ± 0.035 | (↑17%) | 24.25 ± 0.028 | (↑66%) |
| % crude fiber | 5.31 ± 0.24 | 1.99 ± 0.007 | (↓63%) | 1.20 ± 0.021 | (↓77%) | 1.81 ± 0.023 | (↓66%) |
| % NDF | 22.25 ± 0.024 | 9.68 ± 1.71 | (↓57%) | 5.49 ± 0.67 | (↓75%) | 8.42 ± 0.61 | (↓62%) |
| % ADF | 7.00 ± 0.464 | 4.61 ± 0.26 | (↓34%) | 1.97 ± 0.01 | (↓72%) | 3.66 ± 0.74 | (↓48%) |
| % N | 4.44 ± 0.23 | 2.74 ± 0.1 | (↓38%) | 2.07 ± 0.06 | (↓53%) | 2.84 ± 0.05 | (↓36%) |

| | | | | |
|---|---|---|---|---|
| % P | 0.81 ± 0.038 | 0.85 ± 0.04 | 0.81 ± 0.033 | 0.67 ± 0.029 |
| % K | 1.00 ± 0.046 | 0.97 ± 0.11 | 1.01 ± 0.043 | 0.86 ± 0.03 |
| % S | 0.70 ± 0.021 | 0.67 | 0.59 ± 0.006 | 0.66 ± 0.012 |
| ash | 3.25 ± 0.35 | 0.08 ± 0.028 | 0.2 | 0.12 ± 0.07 |
| astaxanthin (μg/g) | 0.00 | 2.73 | 50.91 | |
| β-carotene (μg/g) | 0.00 | 240.00 | 79.86 | 119.99 |

^{a}Means and standard deviation are provided; numbers in parentheses indicate the % increase (↑) or decrease (↓) compared to the control; maximum increase or decrease is boldfaced.
^{b}Kjeldahl.
^{c}Acid hydrolysis.

The amino acid profiles of all the treatments are presented in Table 9. Both monoculture and mixed culture fermentation resulted in lesser amino acids compared to the control. P. rhodozyma reduced the amino acid content by more than 50%, followed by about 40% reduction in mixed culture and S. roseus. Lysine, threonine, tryptophan and methionine are important limiting amino acids in DDGS depending on the animal diet, and levels of these amino acids did not improve with yeast fermentation.

The fatty acid profiles of all the treatments are presented in Table 10. Both monoculture and mixed culture fermentation resulted in higher fatty acids compared to the control. Based on the abundance of different fatty acids (accounting for more than 2% of total fats), both, control and P. rhodozyma fermentation, contained linoleic acid, oleic acid, palmitic acid and stearic acid. Linoleic acid in the control accounted for 52.7% whereas it accounted for only 34.6% in P. rhodozyma. Oleic acid, palmitic acid and stearic acid in P. rhodozyma fermented DDGS were higher than that in the control. Both, S. roseus and mixed culture showed similar fatty acid profiles with vaccenic acid, linoleic acid, palmitic acid and stearic acid being the most abundant in that order. Vaccenic acid was not seen in both the control and P. rhodozyma fermented DDGS, whereas oleic acid was absent in mixed culture and S. roseus fermentation.

TABLE 9
Amino Acid Profile of DDGS and Carotenoid-Enriched DDGS

| | w/w %^{a} | | | |
|---|---|---|---|---|
| amino acids | control | mixed culture | P. rhodozyma | S. roseus |
| taurine | 0.04 | 0.04 ± 0.007 | 0.03 ± 0.007 | 0.04 |
| hydroxyproline | 0.00 | 0.00 | 0.00 | 0.00 |
| aspartic acid | 1.78 ± 0.014 | 1.32 ± 0.028 | 0.81 ± 0.021 | 1.36 |
| threonine | 1.02 ± 0.021 | 0.69 ± 0.014 | 0.64 ± 0.021 | 0.75 ± 0.014 |
| serine | 1.15 ± 0.021 | 0.75 ± 0.021 | 0.65 ± 0.042 | 0.80 ± 0.028 |
| glutamic add | 3.81 ± 0.177 | 1.94 ± 0.014 | 0.98 ± 0.021 | 1.87 ± 0.028 |
| proline | 2.02 ± 0.035 | 0.98 ± 0.021 | 0.76 ± 0.057 | 1.02 ± 0.085 |
| lanthionine | 0.00 | 0.00 | 0.00 | 0.00 |
| glycine | 1.18 ± 0.007 | 0.98 ± 0.021 | 0.62 ± 0.007 | 1.01 ± 0.007 |
| alanine | 1.95 ± 0.021 | 1.00 ± 0.021 | 0.71 ± 0.014 | 1.04 ± 0.007 |
| cysteine | 0.57 | 0.44 ± 0.021 | 0.23 ± 0.007 | 0.45 |
| valine | 1.43 ± 0.021 | 0.86 ± 0.007 | 0.79 ± 0.007 | 0.91 |
| methionine | 0.58 ± 0.007 | 0.27 ± 0.007 | 0.50 ± 0.007 | 0.29 ± 0.007 |
| isoleucine | 1.04 ± 0.007 | 0.62 ± 0.014 | 0.63 ± 0.007 | 0.65 ± 0.014 |
| leucine | 2.99 ± 0.021 | 1.17 ± 0.028 | 1.12 ± 0.007 | 1.24 ± 0.028 |
| tyrosine | 0.94 ± 0.028 | 0.52 ± 0.007 | 0.38 ± 0.057 | 0.51 ± 0.014 |
| phenylalanine | 1.19 | 0.61 ± 0.014 | 0.48 ± 0.007 | 0.61 ± 0.014 |
| hydroxylysine | 0.00 | 0.00 | 0.00 | 0.00 |
| ornithine | 0.04 | 0.04 | 0.01 | 0.04 ± 0.007 |
| lysine | 1.12 ± 0.007 | 0.93 ± 0.021 | 0.74 ± 0.057 | 0.94 ± 0.014 |
| histidine | 0.82 | 0.47 | 0.45 | 0.49 |
| arginine | 1.39 | 0.84 ± 0.007 | 0.61 ± 0.007 | 0.88 ± 0.007 |
| tryptophan | 0.22 ± 0.007 | 0.16 | 0.13 ± 0.007 | 0.18 |
| total | 25.22 ± 0.24 | 14.58 ± 0.28 (↓42%) | 10.91 ± 0.064 (↓57%) | 15.06 ± 0.19 (↓40%) |

^{a}Means and standard deviation are provided; numbers in parentheses indicate the % decrease (↓) compared to the control; the maximum decrease is boldfaced.

TABLE 10
Fatty Acid Profile of DDGS and Carotenoid-Enriched DDGS

| | % of total fat^{a} | | | |
|---|---|---|---|---|
| fatty acid | control | mixed culture | P. rhodozyma | S. roseus |
| myristic (14:0) | 0.06 | 0.45 ± 0.007 | 0.18 | 0.45 |
| myristoleic | | | | |
| (14:1) | 0.00 | 0.00 | 0.00 | 0.00 |
| (C15:0) | 0.00 | 0.13 | 0.09 ± 0.007 | 0.14 |
| palmitic (16:0) | 14.12 ± 0.11 | 14.30 ± 0.021 | 17.59 ± 0.085 | 14.02 ± 0.007 |
| palmitoleic | | | | |
| (16:1) | 0.22 ± 0.064 | 0.84 | 0.16 | 0.69 |
| (17:0) | 0.08 | 0.12 | 0.23 ± 0.007 | 0.12 |
| (17:1) | 0.05 ± 0.007 | 0.12 | 0.05 | 0.12 |
| stearic (18:0) | 2.53 ± 0.1 | 2.98 ± 0.007 | 10.10 ± 0.035 | 4.07 ± 0.007 |
| elaidic (18:1t9) | 0.06 ± 0.007 | 0.12 ± 0.007 | 0.07 | 0.12 ± 0.007 |
| oleic (18:1n9) | 26.98 ± 0.16 | 0.00 | 33.94 | 0.00 |
| vaccenic (18:1n7) | 0.00 | 61.66 ± 0.78 | 0.00 | 60.95 ± 0.071 |
| linoleic (18:2) | 52.70 ± 0.18 | 15.73 ± 0.12 | 34.64 ± 0.14 | 15.41 ± 0.049 |
| linolenic | | | | |
| (ω18:3) | 1.49 ± 0.014 | 0.72 | 0.88 ± 0.007 | 0.74 ± 0.007 |
| (ω18:4) | 0.00 | 0.00 | 0.00 | 0.00 |
| arachidic | | | | |
| (20:0) | 0.44 ± 0.007 | 0.30 | 0.85 | 0.34 |
| (20:1n9) | 0.25 | 0.62 ± 0.007 | 0.09 | 0.66 ± 0.007 |
| (20:3 ω3) | 0.00 | 0.00 | 0.00 | 0.00 |
| arachidonic (20:4n6) | 0.00 | 0.00 | 0.00 | 0.00 |
| arachidonic (20:4 ω3) | 0.00 | 0.00 | 0.00 | 0.00 |
| (20:5 ω3; EPA) | 0.00 | 0.00 | 0.00 | 0.00 |
| docosanoic (22:0) | 0.23 ± 0.042 | 0.45 ± 0.014 | 0.45 | 0.53 |
| erucic (22:1n9) | 0.00 | 0.06 | 0.00 | 0.07 ± 0.007 |
| (22:5 ω3; DPA) | 0.00 | 0.00 | 0.00 | 0.00 |
| (22:6 ω3, DHA) | 0.16 ± 0.007 | 0.09 | 0.03 ± 0.035 | 0.11 |
| lignoceric (24:0) | 0.34 | 0.79 ± 0.007 | 0.32 ± 0.007 | 0.93 |
| nervonic (24:1n9) | 0.00 | 0.03 | 0.00 | 0.03 |
| % crude fat | 14.59 ± 0.1 | 26.35 ± 0.1 (↑81%) | 17.07 ± 0.035 (↑17%) | 24.25 ± 0.028 (↑66%) |

^{a}Means and standard deviation are provided; numbers in parentheses indicate the % increase (↑) compared to the control; the maximum increase is boldfaced.

Red yeast fermentation of DDGS reduced fiber and enhanced fat and polyunsaturated fatty acid (PUFA), modifications which are desirable depending on the specific needs of various animal diets. Red yeast fermentation did not enhance protein content. On the contrary, reduction in protein content, amino acid and % N was observed. Feed blends of carotenoid-enriched DDGS with DDGS or other protein rich sources like soybean products or fish meal can provide optimal protein and/or amino acid levels in DDGS-based animal diets.

High fiber in DDGS, though desirable for ruminants, is responsible for negative effects on poultry growth. Reduction in DDGS fiber can allow the expansion of the DDGS feed base, especially in nonruminant, poultry and aquaculture feeds.

Red yeast fermentation increased the crude fat and fatty acid content and altered the fatty acid composition of DDGS. Soybean oil, oil seeds, vegetable oils, marine oils, or animal fats are often used to supplement fat in animal feeds. Instead, carotenoid-enriched DDGS with enhanced fat can be used to supplement diets. Vaccenic acid, a mono-unsaturated fatty acid, was produced in S. roseus and mixed culture fermentation. Vaccenic acid is primarily found in bovine milk and meat, accounting for 70% of trans fatty acids in ruminant-derived lipids. It is a known precursor of conjugated linoleic acid (CLA), and the principal sources of CLA in human diets are dairy products and ruminant meat. CLA is known to confer many health benefits to animals and humans. Since vaccenic acid is abundant in S. roseus and mixed culture fermented DDGS, providing this to cattle may increase the trans-vaccenic acid (TVA) and CLA levels in milk and meat especially since different types of forages and lipid supplementations are known to exert different effects on milk fat composition and synthesis in cows and goats. Depending on the fat requirement in specific animal feeds, P. rhodozyma fermented DDGS may be more suitable for low-fat feed or feed blends and mixed culture fermented DDGS may be ideal for high fat animal diets.

The red yeast fermentation of DDGS reduced the % N composition from 36% to 53%. This is useful in reducing nitrogen in animal wastes and fish farm effluents. The % P, K and S remained largely unchanged except for 17% and 14% reduction in % P and % K, respectively, by S. roseus, and 15% reduction of % S by P. rhodozyma.

Secondary fermentation of corn whole stillage by red yeasts not only provides carotenoid-enriched DDGS but also brings about two valuable nutritional modifications: increase in fat and reduction in fiber. Additionally, there is reduction in protein and % N.

### Example 5

In this example, the effect of mevalonic acid and certain carotenoid precursors contained in apple and tomato pomace on carotenoid production in red yeast fermentation of various substrates was examined. Lyophilized cultures of Phaffia rhodozyma (ATCC 24202) and Sporobolomyces roseus (ATCC 28988) were obtained from American Type Culture Collection (ATCC, Manassas, Va.). A 10% (v/v) inoculum was used for monoculture fermentation, while 5% of each strain was used in mixed culture fermentation.

For the mevalonic acid addition, optimized media composition of corn whole stillage from Example 3 above was used. Full fat rice bran, defatted rice bran, and wheat bran fermentation media were prepared. A modified synthetic yeast extract medium was used. A liter of the medium contained 1% yeast extract, 1% soy peptone, 2.7% glycerol, traces of KH₂PO₄, MgSO₄, ZnSO₄, and was adjusted to pH 6.0 before sterilization. The basal medium was amended with 5% of full fat rice bran, defatted rice bran, or wheat bran. For the apple pomace and tomato pomace additions, unoptimized corn whole stillage medium outlined in Example 3 above and full fat rice bran medium were used. Precursors were added to the media at respective concentrations and 50 mL of respective media in 250-mL flasks were sterilized by autoclaving at 121° C. for 30 min.

Four concentrations (0, 0.2, 0.4, and 1.0 mg/mL) of mevalonic acid (Sigma, St. Louis, Mo.) were added to whole stillage, full fat rice bran, defatted rice bran, wheat bran, and synthetic media. Apple pomace and tomato pomace at concentrations of 0, 0.05%, 0.1%, and 0.5% were added to whole stillage and full fat rice bran media. Tomato pomace sample contained 62.67 μg/g of lycopene and 99.86 μg/g of β-carotene as determined by HPLC.

Carotenoid production of P. rhodozyma monoculture was evaluated in five substrates (defatted rice bran, full fat rice bran, wheat bran, whole stillage, and synthetic medium) amended with different concentrations of mevalonic acid, and two substrates (full fat rice bran and whole stillage) amended with different concentrations of apple pomace or tomato pomace. The carotenoid production of S. roseus monoculture was evaluated only in two substrates (whole stillage and synthetic medium) amended with mevalonic acid. Many substrates were selected for evaluating the stimulatory effect of mevalonic acid as it is a part of the mevalonate pathway in carotenoid biosynthesis, and its stimulatory effect in P. rhodozyma carotenoid production in synthetic medium is established.

Submerged fermentation was conducted in all cases. Flasks were inoculated and incubated at 18° C., 180 rpm for 11 days. Control flasks without precursors were maintained. Two replicates per treatment were employed. For the mevalonic acid experiment, samples were harvested only on day 11, whereas samples were harvested on days 3, 5, 7, 9, and 11 for the apple pomace and tomato pomace experiments. To keep the number of samples manageable, more substrates were evaluated by harvesting samples only on day 11 in the mevalonate experiment. For the apple pomace and tomato pomace experiments, the carotenoid production profile was of greatest interest because the extracts are of biological origin and could possibly provide chemicals other than the expected precursor compounds influencing the carotenoid synthesis at different time points. Harvested samples were centrifuged and the supernatant was discarded. Pellets were freeze dried for 24 hr and stored at −80° C. until further analyses.

HPLC was used for quantification of carotenoids, astaxanthin, and β-carotene. Carotenoids were extracted in dichloromethane solvent by grinding a known amount of freeze-dried sample with 0.2 g of acid washed sand (40-100 mesh size). Astaxanthin and β-carotene standards were obtained from Sigma. A Shimadzu HPLC equipped with LC-20AB pump, SIL-20AC auto sampler, SPD-M20A PDA detector, and CTO-20A column oven was used. Phenomenex Prodigy C18 column (150 mm length and 4.6 mm, i.d.) along with a C18 guard column was used for the separation of carotenoids. Acetonitrile and methanol (80:20) mobile phase was used. Carotenoid yield was expressed as μg/g of freeze-dried whole stillage sample instead of yield per gram of yeast dry weight, as it was impossible to separate yeast cells from the whole stillage solids.

Data were analyzed using statistical software (v.9.1.4, SAS Institute, Cary, N.C.). PROC GLM was used to compare multiple treatments and when necessary pair-wise comparisons were made using Tukey-Kramer at P=0.05. The effect of precursor concentrations on carotenoid yields for each substrate was determined separately.

As shown in Table 11, carotenoid yield enhancement seems to be influenced by both the fermentation substrate and the concentration of mevalonic acid. Mevalonic acid increased both astaxanthin and β-carotene yields of P. rhodozyma on all substrates except β-carotene yield on wheat bran at 0.02%. The optimal concentration of mevalonic acid that enhanced astaxanthin yield in each substrate was variable: 0.1% in defatted and full fat rice bran resulted in best yield, 0.04% in wheat bran, and 0.02% in whole stillage and synthetic media, respectively. The percent increase in yield was also variable depending on the substrate. The best yield enhancement by 144% and 140% was seen in synthetic medium and whole stillage, respectively. Among all the substrates, P. rhodozyma produced the highest astaxanthin yield of 220 μg/g on whole stillage. β-Carotene yield was enhanced the most by 0.1% mevalonic acid in all substrates. The best yield enhancement by 945% was seen in synthetic medium. However, P. rhodozyma produced the highest yield of β-carotene (904 μg/g) in whole stillage. In S. roseus, the best yield enhancement of β-carotene was seen in synthetic medium with 0.1% mevalonic acid resulting in best yield enhancement by 233%. The maximum yield enhancement of 190% on whole stillage resulted from 0.04% mevalonic acid.

TABLE 11
Effect of Mevalonic Acid on Carotenoid Yield on Different Substrates

| Fungus^{b} and | | | | | | | | |
|---|---|---|---|---|---|---|---|---|
| Carotenoid^{c} | Substrate^{d} | 0% | 0.02% | | 0.04% | | 0.1% | |
| PR | | | | | | | | |
| Astaxanthin | DRB | 49.49 ± 0.1D | 56.33 ± 0.15C | (14%) | 57.9 ± 0.07B | (17%) | 62.41 ± 0.04A | (26%) |
| | FFRB | 45.34 ± 0.63C | 56.54 ± 0.49B | (25%) | 58.0 ± 0.2B | (28%) | 71.68 ± 2.5A | (58%) |
| | WB | 53.03 ± 0.02D | 65.25 ± 0.03C | (23%) | 73.97 ± 0.04A | (40%) | 71.48 ± 0.57B | (35%) |
| | WS | 91.74 ± 2.77B | 220.17 ± 1.19A | (140%) | 213.99 ± 1.85A | (133%) | 211.6 ± 1.5A | (131%) |
| | YM | 71.78 ± 1.45B | 175.42 ± 4.5A | (144%) | 81.33 ± 0.01B | (13%) | 81.3 ± 1.71B | (13%) |
| β-carotene | DRB | 117.93 ± 0.74D | 152.25 ± 1.63B | (29%) | 136.87 ± 0.78C | (16%) | 172.99 ± 3.22A | (47%) |
| | FFRB | 133.66 ± 1.01D | 167.46 ± 0.8C | (25%) | 187.5 ± 1.25B | (40%) | 259.74 ± 6.1A | (94%) |
| | WB | 102.47 ± 0.54C | 94.44 ± 1.02C | (−8%) | 129.96 ± 0.95B | (27%) | 168.25 ± 5.02A | (64%) |
| | WS | 269.18 ± 2.04D | 721.5 ± 19.5C | (168%) | 887.41 ± 6.7B | (230%) | 904.4 ± 1.79A | (236%) |
| | YM | 84.81 ± 3.4B | 743.4 ± 2A | (777%) | 754.34 ± 5.2A | (790%) | 886.54 ± 0.91A | (945%) |
| SR | | | | | | | | |
| β-carotene | WS | 283.79 ± 0.21C | 579.02 ± 9.94B | (104%) | 823.24 ± 5.8A | (190%) | 764.39 ± 1.38A | (169.35%) |
| | YM | 269.62 ± 1.6C | 756.15 ± 1.14B | (180%) | 878.44 ± 12.8A | (226%) | 898.11 ± 4.03A | (233%) |

^{a} Mean values and standard error are reported. Percent increase in yield compared to control in parentheses. Bold type indicates best % yield increase for each substrate. Letters in uppercase provide pair-wise comparison between mevalonic acid treatments for respective substrates. Treatments that do not share a letter are significantly different from each other (P < 0.05).
^{b}PR, Phaffia rhodozyma rhodozyma; SR, Sporobolomyces roseus.
^{c}Carotenoid yield μg/g of freeze-dried sample, except YM where yield is μg/g of yeast.
^{d}DRB, defatted rice bran; FFRB, full-fat rice bran; WB, wheat bran; WS, corn whole stillage; YM, yeast extract malt extract synthetic medium.

The effect of apple and tomato pomace on the production profile of carotenoids on rice bran and whole stillage were determined, and the maximum yield for each substrate-precursor combination was found on different days of harvest. For most treatments, the highest yield was on day 11, but for others the best yield was on day 7 or day 9 as indicated in Table 12. Stimulation of carotenogenesis by the precursor seems to be influenced by both the substrate and the precursor concentration. Overall, apple pomace seems to have a negative influence on astaxanthin production on both substrates (except 0.1% in rice bran and 0.05% in whole stillage), negative influence on β-carotene production in rice bran (except 0.1%), and a positive influence on whole stillage. Apple pomace at 0.1% yielded the best astaxanthin and β-carotene production on rice bran, while 0.05% yielded the best astaxanthin and 0.1% the best β-carotene production on whole stillage. Tomato pomace had a positive influence on astaxanthin and β-carotene production on both substrates except 0.05% on whole stillage. Tomato pomace at 0.05% and 0.5% resulted in the best astaxanthin and β-carotene yields in rice bran, while 0.1% produced the best carotenoid yields in whole stillage.

TABLE 12
Best Carotenoid Yield and Percent Yield Increase in P. rhodozyma Fermentation
of Whole Stillage and Full Fat Rice Bran Amended with Apple or Tomato Pomace

| Caratenoid and | | | | | | | | |
|---|---|---|---|---|---|---|---|---|
| Substrate^{b} | Precursor^{c} | 0% | 0.05% | | 0.1% | | 0.5% | |
| Astaxanthin | | | | | | | | |
| FFRB | AP | 66.36 ± 0.95A | 31.41 ± 0.04B* | (−52.67) | 72.90 ± 2.38A | (9.86) | 59.53 ± 4.68A* | (−10.29) |
| | TP | 66.36 ± 0.95 | 71.71 ± 0.51 | (8.06) | 69.04 ± 3.27 | (4.04) | 69.52 ± 1.51 | (4.76) |
| WS | AP | 32.04 ± 0.71 | 34.48 ± 1.18 | (7.62) | 30.84 ± 2.16* | (−3.75) | 23.20 ± 1.89 | (−27.61) |
| | TP | 32.04 ± 0.71 | 31.25 ± 1.78 | (−2.48) | 41.29 ± 3.73 | (28.87) | 35.85 ± 2.26** | (11.89) |
| β-carotene | | | | | | | | |
| FFRB | AP | 198.29 ± 3.04A | 156.37 ± 4.0B* | (−21.04) | 225.63 ± 7.74A | (13.79) | 182.80 ± 12.51A* | (−7.81) |
| | TP | 198.29 ± 3.04B | 212.71 ± 1.83A | (7.27) | 203.75 ± 7.22AB | (2.75) | 255.00A | (28.60) |
| WS | AP | 130.49 ± 1.65B | 143.82 ± 3.21AB | (10.21) | 164.80 ± 7.81A* | (26.28) | 139.58 ± 1.48B | (6.96) |
| | TP | 130.49 ± 1.65B | 109.53 ± 2.65C | (−16.07) | 162.45 ± 6.94A | (24.49) | 148.42 ± 4.49AB** | (13.73) |

^{a} Mean values and standard error are reported. Highest yield (in most cases on day 11: * yield on day 9; ** yield on day 7) per treatment. Percent increase in yield compared to control in parentheses. Bold type indicates best % yield increase for each substrate. Letters in uppercase provide pair-wise comparison between treatments for respective substrates. Treatments that do not share a letter are significantly different from each other (P < 0.05).
^{b}FFRB, full fat rice bran; WS, corn whole stillage.
^{c}AP, apple pomace; TP, tomato pomace.

This study showed that mevalonic acid, tomato pomace, and apple pomace can act as precursors of carotenoid production in P. rhodozyma fermentation of agricultural substrates. Additionally, the precursor concentrations influenced the level of carotenoid enhancement. However, the yield enhancement was not independent of the substrate. For example, the astaxanthin and β-carotene yield enhancement due to mevalonic acid in P. rhodozyma varied from 144% and 945% in yeast medium to 26% and 47% in defatted rice bran medium, respectively. Interplay between complex media nutrients and precursor compounds and their uptake into the carotenoid biosynthetic pathway seem to be a plausible reason for the observed differences in carotenoid yield enhancement. Overall, mevalonic acid resulted in the best yield enhancement, followed by tomato pomace; apple pomace resulted in least enhancement. Surprisingly, 0.1% mevalonic acid resulted in 945% yield enhancement of β-carotene along with 13% enhancement of astaxanthin. However, the best astaxanthin yield was promoted by 0.02% mevalonic acid. Overall, in S. roseus, mevalonic acid resulted in better yield enhancement of β-carotene in synthetic medium than whole stillage.

Whole stillage and rice bran amended with 0.1% tomato pomace resulted in the best β-carotene yield in both substrates and astaxanthin yield in whole stillage, while rice bran showed negligible improvement of astaxanthin yield. Apple pomace at 0.1% resulted in yield enhancements that were <10% for astaxanthin and 0.26% for β-carotene.

1. A method of making an animal feed product comprising:
providing an animal feed material comprising at least one microorganism species capable of synthesizing one or more nutrients;
subjecting said at least one microorganism species and animal feed material to a fermentation process favorable to formation of said one or more nutrients by said at least one microorganism species thereby creating a nutrient-enriched feed material comprising said animal feed material or residue thereof and said at least one microorganism species or residue thereof; and
processing said nutrient-enriched feed material into said animal feed product.

2. The method according to claim 1, wherein said at least one microorganism species is selected from the group consisting of bacteria, fungi, and combinations thereof.

3. The method according to claim 2, wherein said at least one microorganism species is a yeast.

4. The method according to claim 3, wherein said yeast is selected from the group consisting of Phaffia rhodozyma, Sporobolomyces roseus, and combinations thereof.

5. The method according to claim 1, wherein said feed material comprises one or more members selected from the group consisting of DDGS, soy flour, soy meal, soy hull, wheat bran, rice bran, corn meal, milo whole stillage, and corn whole stillage.

6. The method according to claim 5, wherein said feed material comprises fish meal.

7. (canceled)

8. The method according to claim 1, wherein said fermentation process comprises forming a fermentation medium comprising said animal feed material and said at least one microorganism species.

9. The method according to claim 8, wherein said fermentation medium further comprises one or more additives for improving production of said one or more nutrients by said at least one microorganism species.

10. The method according to claim 9, wherein said one or more additives are selected from the group consisting of glycerol, corn steep liquor, vitamins, minerals, terpene precursors, and mixtures thereof.

11. The method according to claim 1, wherein said one or more nutrients formed by said at least one microorganism species are selected from the group consisting of carotenoids, enzymes, proteins, amino acids, fatty acids, lipids, vitamins, and minerals.

12. The method according to claim 1, wherein said one more nutrients formed by said at least one microorganism species comprise a member selected from the group consisting of astaxanthin, β-carotene, canthaxanthin, tourlene, torularhodin, luetein, and mixtures thereof.

13. The method according to claim 1, wherein said step of processing said nutrient-enriched feed material into said animal feed product includes drying said nutrient-enriched feed material.

14. The method according to claim 1, wherein said step of processing said nutrient-enriched feed material into said animal feed product does not involve removal of said at least one microorganism species from said nutrient-enriched feed material.

15. The method according to any of claim 1, wherein said animal feed material is a co-product from a primary fermentation process, and said step of subjecting said at least one microorganism species and animal feed material to a fermentation process favorable to formation of said at least one nutrient by said at least one microorganism species comprises a secondary fermentation process.

16. The method according to claim 15, wherein said primary fermentation process comprises an ethanol fermentation process.

17. The method according to claim 1, wherein said nutrient-enriched feed material has a fiber content that is lower than the fiber content of said feed material.

18. The method according to claim 1, wherein said nutrient-enriched feed material is lower in nitrogen than said feed material.

19. The method according to claim 1, wherein said nutrient-enriched feed material comprises a higher level of at least one fatty acid than said feed material.

20. The method according to claim 19, wherein said at least one fatty acid comprises vaccenic acid.

21. The method according to claim 1, wherein said nutrient-enriched feed material has a trypsin inhibitor level that is lower than the trypsin inhibitor level of said feed material.

22. The method according to claim 21, wherein said animal feed material is a soybean product.

23. An animal feed product made according to the method of claim 1.

24. An animal feed product comprising:
a solid byproduct of a fermentation process;
a carotenoid-producing yeast or residue thereof; and
one or more carotenoids present in said animal feed product at a level of at least about 100 mg per kg of said animal feed product.

25. The animal feed product according to claim 24, wherein said carotenoid-producing yeast is selected from the group consisting of Phaffia rhodozyma, Sporobolomyces roseus, and combinations thereof.

26. The animal feed product according to claim 24, wherein said solid byproduct comprises a cellulosic material or residue thereof.

27. The animal feed product according to claim 26, wherein said cellulosic material is selected from the group consisting of DDGS, soy flour, soy meal, soy hull, wheat bran, rice bran, corn meal, milo whole stillage, and corn whole stillage.

28. The animal feed product according to claim 24, wherein said solids byproduct comprises fish meal or residue thereof.

29. The animal feed product according to claim 24, wherein said one or more carotenoids are selected from the group consisting of astaxanthin, β-carotene, canthaxanthin, tourlene, torularhodin, luetein, and mixtures thereof.

30. The animal feed product according to claim 24, wherein said one or more carotenoids are present in said animal feed product at a level of between about 100 mg to about 1200 mg per kg of said animal feed product.

31. The animal feed product according to claim 24, said feed product further comprising at least one member selected from the group consisting of glucans, mannans, and glucosamine.

32. A method of feeding an animal comprising the step of feeding to the animal an animal feed product made in accordance with claim 1.

33. A method of feeding an animal comprising the step of feeding to the animal the animal feed product according to claim 24.
